(19) United States
(12) Patent Application Publication
(10) Pub. No.: US 2016/0342001 A1
(43) Pub. Date: Nov. 24, 2016

(54) HOLOGRAPHIC PANEL, MANUFACTURE METHOD THEREOF AND FULL COLOR COHERENT BACKLIGHT DEVICE

(71) Applicant: SHENZHEN CHINA STAR OPTOELECTRONICS TECHNOLOGY CO., LTD., Shenzhen City, Guangdong (CN)

(72) Inventor: Yuan XIONG, Shenzhen, Guangdong (CN)

(73) Assignee: Shenzhen China Star Optoelectronics Technology Co., Ltd., Shenzhen, Guangdong (CN)

(21) Appl. No.: 14/425,626

(22) PCT Filed: Oct. 12, 2014
(86) PCT No.: PCT/CN2014/092771

§ 371 Date: Mar. 3, 2015

(30) Foreign Application Priority Data
Nov. 11, 2014 (CN) 201410631862.4

(51) Int. Cl. G02F 1/1334; G02F 1/1341; G03H 1/02; G02F 1/1343

(52) U.S. Cl. CPC G02F 1/13342; G02F 1/13439; G02F 1/1341; G03H 1/02; G03H 2226/00

(57) ABSTRACT

The present invention discloses a holographic panel, a manufacture method thereof and a full color coherent backlight device. The holographic panel comprises a first substrate, a second substrate and a polymer dispersed liquid crystal between the first substrate and the second substrate, the polymer dispersed liquid crystal is formed corresponding to a holographic fringe of a predetermined wavelength range, and electrode is manufactured on at least one of the first substrate and the second substrate, wherein the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage. With the foregoing arrangement, the present invention can provide a large area coherent backlight for a full 3D display.

### FIELD OF THE INVENTION

The present invention relates to a touch screen technology field, and more particularly to a mutual capacitance one glass solution holographic panel and a manufacture method thereof.

### BACKGROUND OF THE INVENTION

In the present dynamic holographic 3D display system, most of the backlight modules utilize elements, such as beam expanding lens, small holes, et cetera to expand the small diameter laser source into a large area collimating coherent backlight source. It is utilized by a spatial light modulator for loading information to an incident large area coherent field. A certain light distance is required to realize the expanding effect for the beam expanding lens, the small holes, et cetera of the backlight modules. The solution of light distance folding may decrease the demanding occupied space of the back light module but the utilization of space is less ideal, which cannot realize a large area, light, thin backlight module. Accordingly, it is very difficult to flatten the whole dynamic holographic 3D display system.

### SUMMARY OF THE INVENTION

An objective of the present invention is to provide a holographic panel, a manufacture method thereof and a full color coherent backlight device to provide a large area coherent backlight for a full 3D display.

For solving the aforesaid technical issues, the present invention provides a holographic panel, comprising a first substrate, a second substrate and a polymer dispersed liquid crystal between the first substrate and the second substrate, the polymer dispersed liquid crystal is formed corresponding to a holographic fringe of a predetermined wavelength range, and electrode is manufactured on at least one of the first substrate and the second substrate, wherein the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage.

A gap between the first substrate and the second substrate is not less than 35 μm.

The polymer dispersed liquid crystal is consisted of Trimethylolpropane Triacrylate, N-Vinyl-2-pyrrolidone, N-phenylglycine, rhodizonic acid and liquid crystal material with a predetermined mass ratio.

The incident light obliquely enters into the holographic panel and the collimating coherent light perpendicularly exists from the holographic panel, and an exit direction of the collimating coherent light and a perpendicular component of the incident light relative to the holographic panel are mutually opposite.

For solving the aforesaid technical issues, the present invention provides a manufacture method of a holographic panel, comprising manufacturing electrode on at least one of the first substrate and the second substrate; filling polymer dispersed liquid crystal between the first substrate and the second substrate, and the polymer dispersed liquid crystal comprises dye to absorb light of predetermined wavelength range; employing the light of predetermined wavelength range to implement exposure to the polymer dispersed liquid crystal when the electrode is not applied with a voltage to form a holographic fringe in the polymer dispersed liquid crystal.

The holographic fringe makes that the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage.

A gap between the first substrate and the second substrate is not less than 35 μm.

For solving the aforesaid technical issues, the present invention provides a full color coherent backlight device, comprising at least three aforesaid holographic panels which are stacking up, wherein each holographic panel corresponds to various predetermined wavelength ranges.

An amount of the holographic panels is three, which respectively correspond to a red light wavelength range, a green light wavelength range and a blue light wavelength range.

Voltages are alternately applied to the at least three holographic panels as functioning to make the at least three holographic panels alternately output collimating coherent lights of various predetermined wavelength ranges.

With the aforesaid solutions, the benefits of the present invention are: between the first substrate and the second substrate, the polymer dispersed liquid crystal is formed corresponding to a holographic fringe of predetermined wavelength range, and the electrode is manufactured on at least one of the first substrate and the second substrate, the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage and can provide a large area coherent backlight for a full 3D display.

### BRIEF DESCRIPTION OF THE DRAWINGS

FIG. 1 is a structural diagram of a holographic panel according to the embodiment of the present invention;

FIG. 2 is a functioning diagram of the holographic panel when a voltage is applied;

FIG. 3 is a flowchart of a manufacture method of the holographic panel according to the embodiment of the present invention;

FIG. 4 is a structural diagram of a full color coherent backlight device according to the embodiment of the present invention.

### DETAILED DESCRIPTION OF PREFERRED EMBODIMENTS

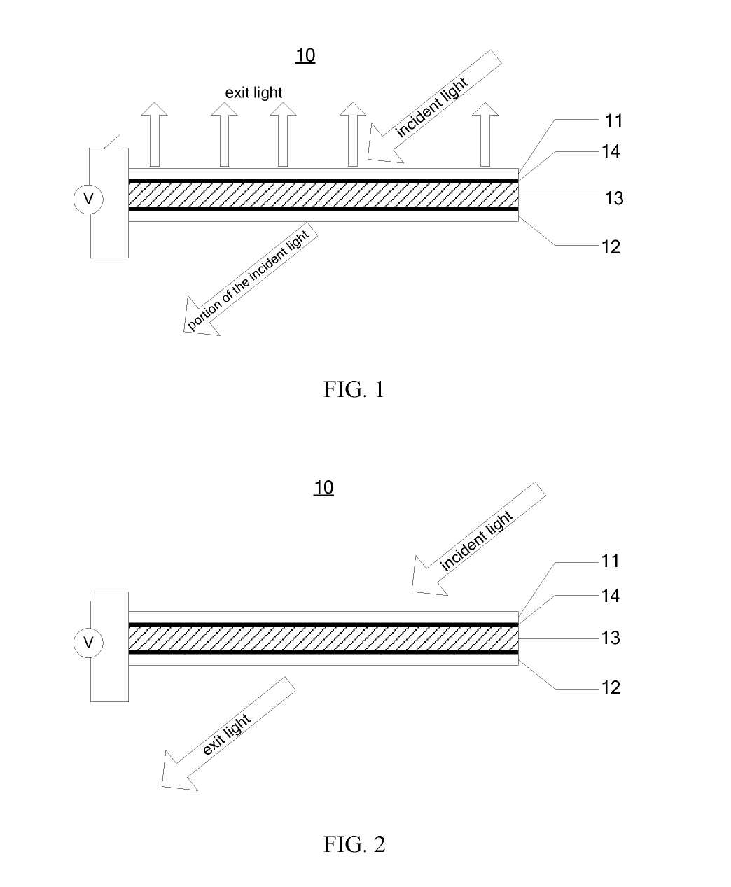

Please refer to FIG. 1. FIG. 1 is a structural diagram of a holographic panel according to the embodiment of the present invention. As shown in FIG. 1, the holographic panel 10 comprises a first substrate 11, a second substrate 12 and a polymer dispersed liquid crystal 13 between the first substrate 11 and the second substrate 12, the polymer dispersed liquid crystal 13 is formed corresponding to a holographic fringe of predetermined wavelength range, and electrode 14 is manufactured on at least one of the first substrate 11 and the second substrate 12. The polymer dispersed liquid crystal 13 converts an incident light into a collimating coherent light and exits the collimating coherent light when the electrode 14 is not applied with a voltage, and the polymer dispersed liquid crystal 13 is transparentized to the incident light of the predetermined wavelength range when the electrode 14 is applied with a voltage V.

In the embodiment of the present invention, a gap between the first substrate 11 and the second substrate 12 is not less than 35 μm for ensuring the record quality of the holographic fringe. The polymer dispersed liquid crystal 13 comprises various dyes to have absorbing wavelengths correspondingly for taking effect to the incident light of predetermined wavelength range. Specifically, the polymer dispersed liquid crystal 13 is consisted of Trimethylolpropane Triacrylate, N-Vinyl-2-pyrrolidone, N-phenylglycine, rhodizonic acid and liquid crystal material with a predetermined mass ratio. With the recipe of certain mass ratio, the polymer dispersed liquid crystal 13 consisted of the aforesaid components occurs polymerization under condition of exposure of blue, green wavelength range (450-550 nm). By certain exposure path arrangement, holographic images can be formed to convert the scattered light of the wavelength range into collimating coherent light and exit it.

As shown in FIG. 1, under circumstance that voltage is not applied, the polymer dispersed liquid crystal 13 employs the incident light of predetermined wavelength range to implement exposure process to make the holographic panel 10 covert the scattered light of the predetermined wavelength into the collimating coherent light and exit it. The incident light obliquely enters into the holographic panel 10 and the collimating coherent light perpendicularly exists from the holographic panel 10, and an exit direction of the collimating coherent light and a perpendicular component of the incident light relative to the holographic panel 10 are mutually opposite. Specifically, the incident light obliquely enters into the holographic panel 10. Because the refractivity of the polymer dispersed liquid crystal 13 changes at different positions, the scattered light is formed in the holographic panel 10 to make the polymer dispersed liquid crystal 13 covert the scattered light of the predetermined wavelength range into the collimating coherent light and exit it. The exit light is distributed over the entire holographic panel 10 and forms a large area coherent backlight. The rest portion of the light exits from the other side by passing through the holographic panel 10. As shown in FIG. 2, after the exposure process, with applying a certain voltage V to the electrode 14, the holographic panel 10 losses the ability of converting the scattered light into the collimating coherent light and can be penetrated by the visible light without obvious loss.

In the embodiment of the present invention, by adjusting the components of the polymer dispersed liquid crystal 13, the holographic panel 10 can convert the incident light of various wavelength ranges into the collimating coherent light and exits it. Preferably, such as a red light wavelength range, a green light wavelength range and a blue light wavelength range which can provide the large area coherent backlight for a full 3D display.

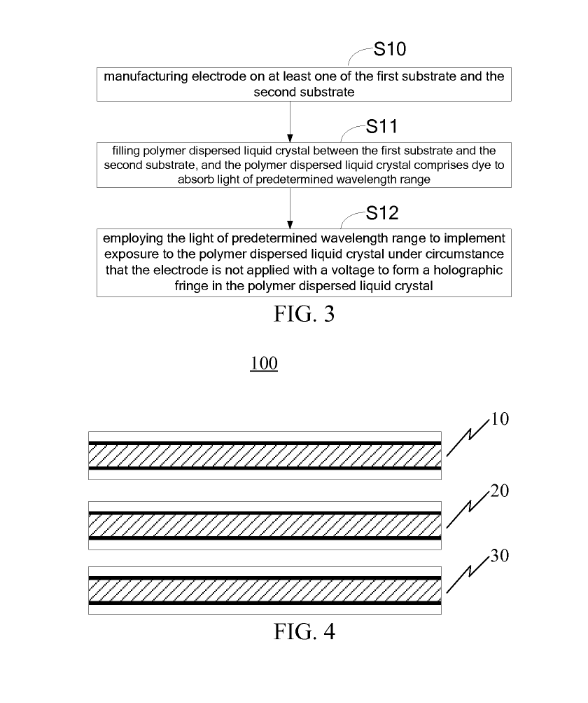

FIG. 3 is a flowchart of a manufacture method of the holographic panel according to the embodiment of the present invention. As shown in FIG. 3, the manufacture method of the holographic panel comprises:

Step S10, manufacturing electrode on at least one of the first substrate and the second substrate. Certainly, the electrode can be manufactured on both the first substrate and the second substrate. By applying or not applying the voltage to the electrode, the holographic panels for different scenarios.

Step S11, filling polymer dispersed liquid crystal between the first substrate and the second substrate, and the polymer dispersed liquid crystal comprises dye to absorb light of predetermined wavelength range.

Specifically, Trimethylolpropane Triacrylate, N-Vinyl-2-pyrrolidone, N-phenylglycine, rhodizonic acid and liquid crystal material of the polymer dispersed liquid crystal are consisted with a predetermined mass ratio. With the recipe of certain mass ratio, the polymer dispersed liquid crystal 13 consisted of the aforesaid components occurs polymerization under condition of exposure of blue, green wavelength range (450-550 nm). By certain exposure path arrangement, holographic images can be formed to convert the scattered light of the wavelength range into collimating coherent light and exit it.

Step S12, employing the light of predetermined wavelength range to implement exposure to the polymer dispersed liquid crystal under circumstance that the electrode is not applied with a voltage to form a holographic fringe in the polymer dispersed liquid crystal.

With the holographic fringe, the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage. The refractivity of the polymer dispersed liquid crystal changes at different positions, the scattered light is formed in the holographic panel to make the polymer dispersed liquid crystal covert the scattered light of the predetermined wavelength range into the collimating coherent light and exit it. The exit light is distributed over the entire holographic panel and forms a large area coherent backlight. After the exposure process, with applying a certain voltage to the electrode, the holographic panel losses the ability of converting the scattered light into the collimating coherent light and can be penetrated by the visible light without obvious loss.

In the embodiment of the present invention, a gap between the first substrate and the second substrate is not less than 35 μm. By adjusting the components of the polymer dispersed liquid crystal 13, the holographic panel 10 can convert the incident light of various wavelength ranges into the collimating coherent light and exits it. Preferably, such as a red light wavelength range, a green light wavelength range and a blue light wavelength range which can provide the large area coherent backlight for a full 3D display.

FIG. 4 is a structural diagram of a full color coherent backlight device according to the embodiment of the present invention. As shown in FIG. 4, the full color coherent backlight device 100 comprises at least three holographic panels 10, 20, 30 which are stacking up. Each holographic panel corresponds to various predetermined wavelength ranges. There are three holographic panels respectively corresponding to a red light wavelength range, a green light wavelength range and a blue light wavelength range. The three holographic panels 10, 20, 30 respectively correspond to various predetermined wavelengths. When one of them, such as the holographic panel 10 functions, the light of corresponding wavelength enters, the voltages are applied to the rest two holographic panels 20, 30 to transparentize them. The light of the wavelength is converted into the collimating coherent light and exited. With the sequential function activation in time, the full color backlight can be achievable. Specifically, voltages are alternately applied to the at least three holographic panels 10, 20, 30 as functioning to make the at least three collimating coherent lights of various predetermined wavelength ranges outputted. For instance, as the holographic panel 10 is a holographic panel of a red light wavelength range, and the light of red light wavelength range is required to output, voltages are applied to the electrodes of the two holographic panels 20, 30 of a green light wavelength range and a blue light wavelength range to transparentize the two holographic panels 20, 30 but not to the holographic panel 10 of the red light wavelength range. The polymer dispersed liquid crystal converts the incident light of the red light wavelength range into the collimating coherent light and exits it.

In the embodiment of the present invention, at least three holographic panels 10, 20, 30 which are stacking up are employed to be sequentially and alternately applied with voltages to make the at least three holographic panels 10, 20, 30 alternately output the collimating coherent lights of various predetermined wavelength ranges to achieve providing a large area coherent backlight for a full 3D display.

In conclusion, according to the present invention, between the first substrate and the second substrate, the polymer dispersed liquid crystal is formed corresponding to a holographic fringe of predetermined wavelength range, and the electrode is manufactured on at least one of the first substrate and the second substrate, the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage and can provide a large area coherent backlight for a full 3D display.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A holographic panel, wherein the holographic panel comprises a first substrate, a second substrate and a polymer dispersed liquid crystal between the first substrate and the second substrate, the polymer dispersed liquid crystal is formed corresponding to a holographic fringe of a predetermined wavelength range, and electrode is manufactured on at least one of the first substrate and the second substrate, wherein the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage.

2. The holographic panel according to claim 1, wherein a gap between the first substrate and the second substrate is not less than 35 μm.

3. The holographic panel according to claim 1, wherein the polymer dispersed liquid crystal is consisted of Trimethylolpropane Triacrylate, N-Vinyl-2-pyrrolidone, N-phenylglycine, rhodizonic acid and liquid crystal material with a predetermined mass ratio.

4. The holographic panel according to claim 1, wherein the incident light obliquely enters into the holographic panel and the collimating coherent light perpendicularly exists from the holographic panel, and an exit direction of the collimating coherent light and a perpendicular component of the incident light relative to the holographic panel are mutually opposite.

5. A manufacture method of a holographic panel, wherein the method comprises:
manufacturing electrode on at least one of the first substrate and the second substrate;
filling polymer dispersed liquid crystal between the first substrate and the second substrate, and the polymer dispersed liquid crystal comprises dye to absorb light of predetermined wavelength range;
employing the light of predetermined wavelength range to implement exposure to the polymer dispersed liquid crystal when the electrode is not applied with a voltage to form a holographic fringe in the polymer dispersed liquid crystal.

6. The method according to claim 5, wherein the holographic fringe makes that the polymer dispersed liquid crystal converts an incident light into a collimating coherent light and exits the collimating coherent light when the electrode is not applied with a voltage, and the polymer dispersed liquid crystal is transparentized to the incident light of the predetermined wavelength range when the electrode is applied with a voltage.

7. The method according to claim 5, wherein a gap between the first substrate and the second substrate is not less than 35 μm.

8. A full color coherent backlight device, wherein the full color coherent backlight device comprises at least three stacking up holographic panels according to one of claims 1 to 4, wherein each holographic panel corresponds to various predetermined wavelength ranges.

9. The device according to claim 8, wherein an amount of the holographic panels is three, which respectively correspond to a red light wavelength range, a green light wavelength range and a blue light wavelength range.

10. The device according to claim 8, voltages are alternately applied to the at least three holographic panels as functioning to make the at least three holographic panels alternately output collimating coherent lights of various predetermined wavelength ranges.
